(19) United States
(12) Patent Application Publication
(10) Pub. No.: US 2007/0222756 A1
(43) Pub. Date: Sep. 27, 2007

(54) OPTICAL MOUSE HAVING AN OPTICAL STRUCTURE CAPABLE OF HIGH SENSIBILITY

(75) Inventors: Chun-Che Wu, Chung Ho City (TW); Chun-Ching Peng, Chung Ho City (TW)

Correspondence Address: PAI PATENT & TRADEMARK LAW FIRM, 1001 FOURTH AVENUE, SUITE 3200, SEATTLE, WA, 98154, US

(73) Assignee: CHIC TECHNOLOGY CORP., Chung Ho City (TW)

(21) Appl. No.: 11/308,419

(22) Filed: Mar. 23, 2006

(51) Int. Cl. G09G 5/08

(52) U.S. Cl. 345/165

(57) ABSTRACT

An optical structure of the optical mouse is disclosed, which comprises a light source providing an incident light beam transmitted onto a target surface at a specific incident angle and a photosensor pre-disposed at an angle of between 1 and 179 degrees or between 181 and 359 degrees so as to be aligned to stand at a right angle with respect to a path of the reflected version and thus achieve a proper acquirement of luminance and image of the reflected version of the incident light from the target surface.

### BACKGROUND OF THE INVENTION

1. Field of the Invention

The present invention pertains to an optical mouse having an optical structure capable of high sensibility. Particularly, the present invention pertains to an optical mouse having an optical structure capable of high sensibility, in which a photosensor is disposed at an angle of between 1 to 179 degrees or between 181 and 359 degrees so as to be aligned to stand at a right angle with respect to a path of a reflected light to achieve a proper acquirement of luminance of the reflected light.

2. Description of the Prior Art

Mouse is an indispensable peripheral device to a computer since it can supercede a keyboard, having a much bigger volume as compared thereto, in inputting to the computer due to the superior manipulativeness, particularly for use in manipulation of web pages and multi-media. Form of the mouse has advanced from a roller mouse form used in the past to an optical mouse form used today. As generally known, the conventional roller mouse is inherent with disadvantages of susceptibility of wear of the roller and deposition of filth inside the mouse enclosed by the roller. On the other hand, the new generation optical mouse not only provides the advantages of being wear-proof and preventive of filth deposition, but also the advantage that precision thereof will not decay as use time thereof increases. For these reasons, such optical mouse has replaced the conventional roller mouse completely and thus become a best choice of mouse for users.

In terms of operation of the optical mouse, a light source (typically, a red light source) is used to impinge a light beam onto a target surface and a reflected version of the light is acquired on a regular basis. By means of comparison of the light acquired several times per second, moving directions and moving distances of the optical mouse may be known. Apparently, precision of image acquirement by the optical mouse has a critical effect on performance of the optical mouse.

Since response speed of the optical mouse is determined by precision of image acquirement by the mouse, pixel size of a photosensor in the optical mouse has to be small up to a specific extent. Further, whether the light reflected by the target surface can be properly acquired by the photosensor may also determine the precision of image acquirement by the mouse. That is, the more proper the acquirement of the reflected light is, the better the precision of the optical mouse is.

A generally used optical mouse may be seen in, for example, TW patent 245538, entitled “Improved optical mouse structure”. In this patent, the improved structure is composed by a light source used to emit a light beam (a light emitting device) and a photosensor (an image sensing device). Specifically, the photosensor is disposed opposite to the target surface and the reflected light from the target surface is incident to the photosensor at a non-right angle. In this configuration, the photosensor is used to acquire the reflected light and make an image analysis over the acquired image (the reflected light). Based on position of the light impinged on the target surface, which varies as the optical mouse moves on the target surface, a moving distance of the optical mouse may be determined since the reflected light also varies as the position changes.

However, since the photosensor does not receive the reflected light at a right angle considered as an optimal angle, the received light may have a loss, which is particularly critical when the reflected light is not sufficient in luminance, leading to insufficient data for the to-be-performed image analysis. At this time, a cursor corresponding to the optical mouse is displayed in an undesired jiggled or deviated state.

To prevent the condition where data for image analysis are insufficiently acquired from occurring, it is generally suggested to promote power and thus luminance of the light source. However, this causes a higher power cost and may not achieve the energy saving purpose.

Furthermore, since the target surfaces associated with the use of the optical mouse are not always the same in any case, e.g. being made of different materials, such as a transparent glass and a plastic material, the incident light beam beams from the light source contact target surfaces of different indices of refraction and thus different reflected light beams are produced. Therefore, the photosensor may not be disposed at an optimal direction and the path of the reflected light may be caused to walk off. As such, the photosensor may not receive the reflected light in a desired or devised manner.

In view of these problems encountered in the prior art, the Inventors have paid many efforts in the related research and finally developed successfully an optical mouse having an optical structure capable of high sensibility, which is taken as the present invention.

### SUMMARY OF THE INVENTION

It is, therefore, an object of the present invention to provide an optical mouse having an optical structure capable of high sensibility, in which a photosensor is disposed at an optimal angle of between 1 and 179 degrees or between 181 and 359 degrees where the photosensor stands at a right angle with respect to a path of a reflected version of a light beam emitted from a light source. It is to be noted that the light reflection is different as the surface of the substance contacted with the light varies and the light is always reflected along a minimum path (a chopstick seeming like broken may be an example). As such, the reflected light may be acquired with a minimum loss and the purpose of energy saving is achieved. In this manner, a cursor controlled by the optical mouse may move on a display with a considerable precision.

To achieve the above object, the optical structure of the optical mouse according to the present invention comprises a light source providing an incident light beam transmitted onto a target surface at a specific incident angle and a photosensor pre-disposed at an angle of between 1 and 179 degrees or between 181 and 359 degrees so as to be aligned to stand at a right angle with respect to achieve a proper acquirement of luminance and image of the reflected light from the target surface.

### BRIEF DESCRIPTION OF THE DRAWINGS

The drawings disclose an illustrative embodiment of the present invention which serves to exemplify the various advantages and objects hereof, and are as follows:

FIG. 1 shows a cross sectional view of an optical mouse having an optical structure capable of high sensibility according to the present invention;

FIG. 2 shows a perspective view of the optical mouse having the optical structure capable of high sensibility according to the present invention;

FIG. 3 shows a schematic diagram of the optical mouse having the optical structure capable of high sensibility according to the present invention;

FIG. 4 shows a schematic diagram illustrating motion of an incident light beam and a reflected version thereof involved in the optical mouse having the optical structure capable of high sensibility according to an embodiment of the present invention; and

FIG. 5 shows a schematic diagram illustrating motion of the incident light beam and the reflected version thereof involved in the optical mouse having the optical structure capable of high sensibility according to another embodiment of the present invention.

### DETAILED DESCRIPTION OF THE PREFERRED EMBODIMENT

To enable the present invention to be fully understood, the present invention will be described in detail below taken from the preferred embodiments with reference to the annexed drawings.

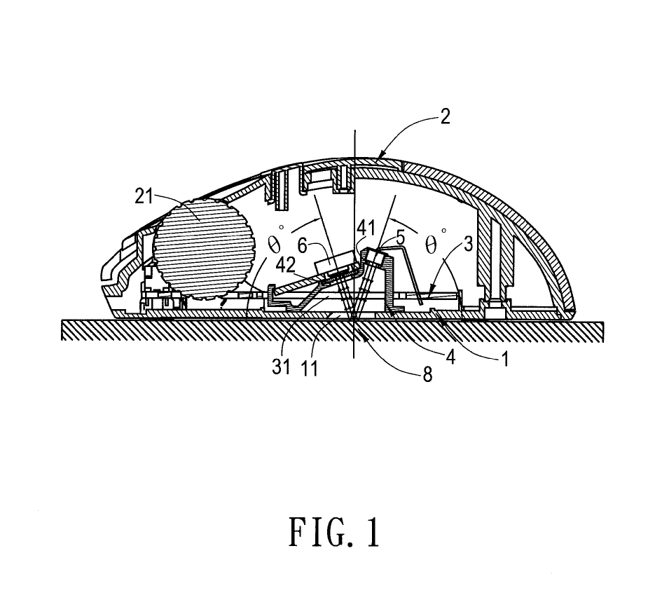

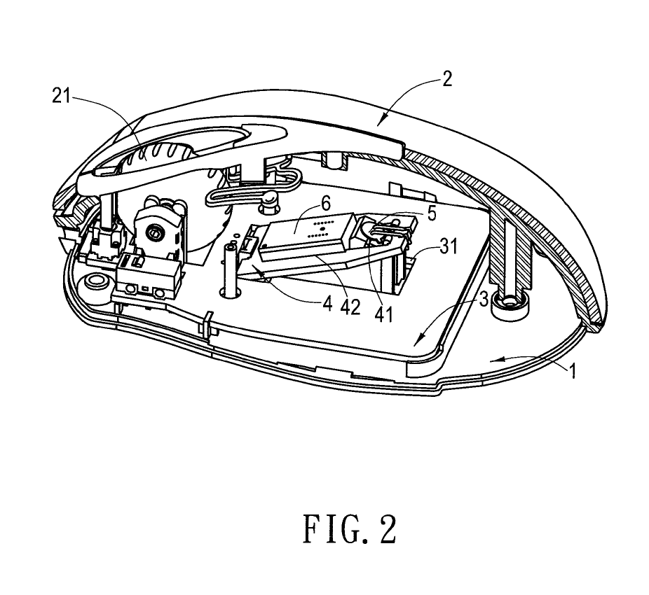

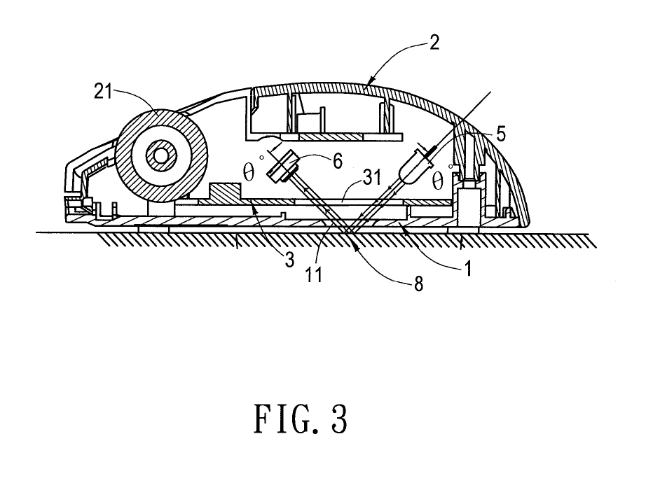

Referring first to FIG. 1, FIG. 2 and FIG. 3, an optical mouse according to the present invention may be manipulated on a target surface 8 and comprises a base 1, an upper cover 2, a circuit board 3, a support frame 4, a light source 5 and a photosensor 6. The target surface 8 may be any suitable surface such as a mouse pad surface, a desk surface, a glass surface and a plastic surface. The base 1 has a through-hole 11 at a bottom end thereof. The upper case 2 is disposed over the base 1 and has a set of control keys 2 thereon. The circuit board 3 is disposed on the base 1 and has a reception hole 31 aligned to the through-hole 11. The support frame 4 is disposed at an upper end of the circuit board 3 and connected to the base 1. Further, a first positioning hole 41 and a second positioning hole 42 are provided on the support frame 4 at respective angles for holding the light source 5 and the photosensor 6, respectively. The light source 5 may emit a visible light and other suitable light beams and may be laser, red, white and blue light emitting diodes (LEDs). Alternatively, the light source 5 may emit a non-visible light such as a laser light, an infrared ray and the like. The light source 5 is disposed with respect to the first positioning hole 41 and contacts electrically the circuit board 3 so that the light source 5 is supplied with a power to emit an incident light beam. The incident light beam is transmitted onto the target surface 8.

The photosensor 6 is supported on another end of the support frame 4 and disposed at an angle of between 1 and 179 degrees or between 181 and 359 degrees so as to be aligned to a path of a reflected version of the incident light beam from the target surface and receives the reflected version. It is to be noted that the light reflection is different as the substance surface varies and the light is always reflected along a minimum path (a chopstick seeming like broken may be an example) where the photosensor 6 stands at a right angle with respect to the optical path. Further, a reflection angle of the reflected version is exactly equal to the corresponding incident angle of the incident light beam onto the target surface 8.

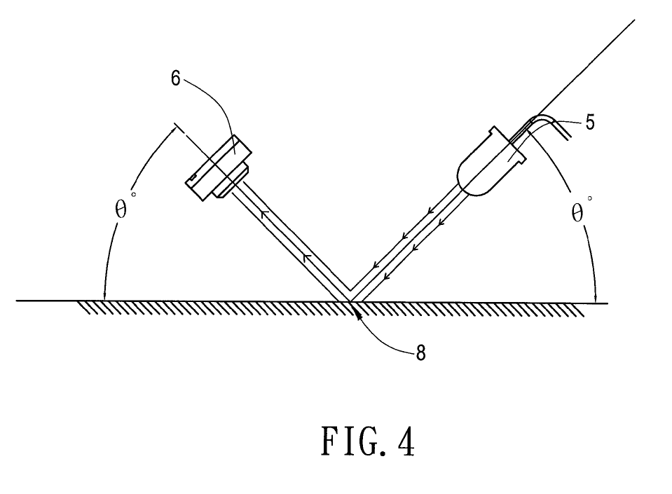

Since each light source may have different wavelength as compared to that of others, the different lights may suffer different losses (refraction loss may be also possible in some environment such as rainbow) when passing different media (air, lens or ambient light), the results when they contact with an object surface. At this time, the reflected light received by each photosensor 6 is different in terms of the wavelength. To solve this problem, the light source 5 or photosensor 6 has to be pre-adjusted so that the image of the object surface 8 can be properly acquired by the photosensor 6. Accordingly, the photosensor 6 is, in the present invention, supported by the support frame 4 and pre-disposed at an angle of between 1 and 179 degrees or between 181 and 359 degrees so that the photosensor 6 may stand at a right angle with respect to the path of the reflected version of the light emitted from the light source 5, such as a laser, a red, a white and a blue LEDs and an infrared ray emitting device, which is shown in FIG. 3 and FIG. 4. As such, image of the target surface 8 may be acquired by the photosensor 6. Specifically, when the light emitted by the light source 5 can pass through the through hole 11 of the base 1 and the reception hole 31 of the circuit board 3 at a specific incident angle, the light may be reflected when contacting the target surface 8. At this time, the photosensor 6 may properly acquire the reflected version from the target surface 8 at a position where the reflected version contacts. When the optical mouse moves on the target surface 8, image of the reflected version may be acquired by being scanned with the photosensor 6 on a regular basis, such as several times per second. After being subject to analysis and comparison, the acquired image may be used to determine moving directions and distances of the cursor on a display corresponding to motion of the optical mouse.

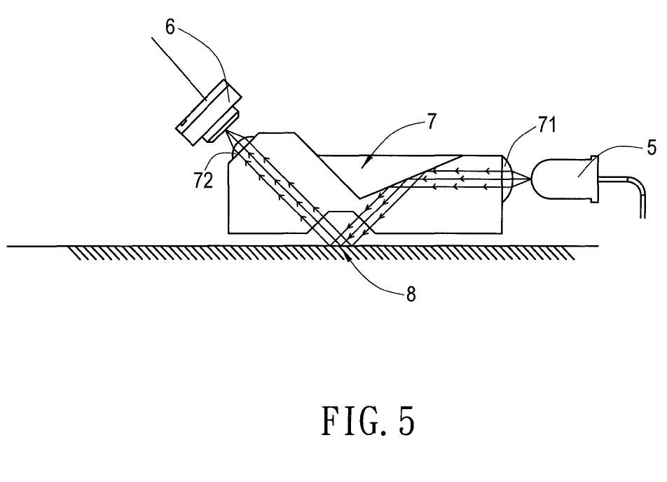

FIG. 5 shows a schematic diagram illustrating motion of the incident light beam and the reflected version thereof involved in the optical mouse having the optical structure capable of high sensibility according to another embodiment of the present invention. In this embodiment, the light source 5 may be disposed at an arbitrary angle and a lens 7 is disposed among the light source 5, the photosensor 6 and the target surface 8 and at a position where the incident light beam and the reflected version thereof pass. The lens 7 is provided to change an incident angle of the incident light beam so that the incident light beam is guided onto the target surface and the reflected version is passed without being refracted. The lens 7 has a first arc surface 71 at a portion corresponding to the light source 5 and a second arc surface 72 at a portion corresponding to the photosensor 6, the first arc surface being used to collect the light emitted by the light source 5 and the second arc surface being used to focus the reflected version from the target surface 8 so as to be received by the photosensor 6.

In the above configuration shown in FIG. 5, since a color of an object is presented as a reflected light obtained when the object is impinged, a specific wavelength of the reflected light results in the represented color. In FIG. 5, the lens 7 is a medium through which a light is allowed to transmit. When the light source 5 generates a diffused light beam, the first arc surface 71 of the lens 7, being a convex lens, is used to collect the diffused light. Specifically, the diffused light may be transformed into a collimated light through the first arc surface 71. When the collimated light is refracted at a normal direction, it is transmitted onto the target surface 8 after passing through the lens 7. Then, the light is refracted from the target surface 8 to the lens 7. Thereafter, the light is focused at the second arc surface 72 of the lens 7 so that the refracted light by the target surface 8 is limited to a range which may be detected by the optical sensor 6. With related to the reflected version of the refracted light, it is focused by the second arc surface 72 of the lens 7 to be received by the photosensor 6. As such, the required luminance of the light for image analysis may be reduced and the photosensor 6 may acquire the image corresponding to the refracted light in a considerable precision. Further, the first arc surface 71 of the lens 7 may be a concave arc surface according to type and luminance of the used light source 5 so as to diffuse the light emitted by the light source 5 and cause a change to direction of the light so that a refracted light is incident onto the target surface 8 at a new incident angle. Further, the reflected version from the target surface 8 is first scattered by the second arc surface 72 of the lens 7 and then received by the photosensor 6. As such, the reflected version is properly received by the photosensor 6 and the photosensor 6 may acquire image of the reflected version in a considerable precision.

The optical mouse having an optical structure capable of high sensibility of this invention provides the following advantages.

1. The photosensor is disposed at a preset angle of between 1 and 179 degrees or between 181 and 359 degrees so that the photosensor may be aligned to stand at a right angle with respect to the path of the reflected version of the incident light beam and thus the photosensor may properly acquire the reflected version of the incident light beam. As such, the image of the target surface may be acquired in a considerable precision and thus a cursor on a display controlled by the optical mouse may be moved in a considerable precision.

2. With the additionally disposed lens 7, the incident angle of the incident light beam may be modified and the incident light beam may be focused and thus the light power may be increased. As such, energy waste may be prevented and the photosensor may acquire image of the target surface in a considerable precision.

3. In case of an overly strong light being emitted by the light source, the photosensor may be first modified by a specific angle and then the first and second arc surfaces may be used to further adjust reception of the reflected version by the photosensor. As such, the reflected version may be properly received by the photosensor and thus the photosensor may acquire image of the target surface in a considerable precision.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An input device having an optical structure capable of high sensibility, comprising:
a light source providing an incident light beam transmitted onto a target surface at a specific incident angle; and
a photosensor pre-disposed at an angle of between 1 and 179 degrees or between 181 and 359 degrees so as to stand at a right angle with respect to a path of a reflected light to scan and acquire properly a luminance of the reflected version of the incident light beam,
whereby the photosensor is disposed at the right angle for reception of the reflected version of the incident light beam so that image of the target surface is properly scanned and acquired by the photosensor.

2. The input device having an optical structure capable of high sensibility according to claim 1, wherein the light source comprises a visible light source.

3. The input device having an optical structure capable of high sensibility according to claim 1, wherein the light source comprises an invisible light source.

4. The input device having an optical structure capable of high sensibility according to claim 1, wherein a lens is provided between the light source and the target surface and is passed by the incident light beam to refract the incident light beam and guide the incident light beam onto the target surface.

5. The input device having an optical structure capable of high sensibility according to claim 4, wherein the lens has a first arc surface used to collect the incident light beam.

6. The input device having an optical structure capable of high sensibility according to claim 4, wherein the lens is disposed so that the reflected version of the incident light beam is collected by the lens.

7. The input device having an optical structure capable of high sensibility according to claim 6, wherein the lens is disposed between the photosensor and the target surface and has a second arc surface used to focus or diffuse the reflected version of the incident light beam so that the photosensor collects the reflected version of the incident light beam.

8. The input device having an optical structure capable of high sensibility according to claim 1, wherein the incident angle is equal to a reflection angle with which the reflected version of the incident light beam leaves the target surface.

9. The input device having an optical structure capable of high sensibility according to claim 1, wherein the photosensor is disposed at a right angle with respect to the path of the reflected version of the incident light beam.

10. An optical mouse having an optical structure capable of high sensibility, comprising:
a base having a through-hole at a bottom end thereof;
an upper case disposed over the base and having a set of control keys thereon. a circuit board disposed on the base and having a reception hole aligned to the through-hole;
a support frame disposed at an upper end of the circuit board and connected to the base;
a light source disposed on an end of the support frame and connected electrically to the circuit board to provide an incident light beam transmitted onto a target surface at a specific incident angle; and
a photosensor pre-disposed on another end of the support frame at an angle of between 1 and 179 degrees or between 181 and 359 degrees so as to stand at a right angle with respect to a path of a reflected version of the incident light beam to scan and acquire properly a luminance of the reflected version of the incident light beam, wherein the incident angle is equal to a reflection angle with which the reflected version of the incident light beam leaves the target surface,
whereby the photosensor is disposed at the right angle for reception of the reflected version of the incident light beam so that image of the target surface is properly scanned and acquired by the photosensor.

11. The optical mouse having an optical structure capable of high sensibility according to claim 10, wherein the support frame has a first positioning hole disposed thereon at a specific angle to hold the light source and a second positioning hole disposed thereon at another specific angle to hold the photosensor so that the incident light beam emitted by the light source is transmitted to the target surface at the specific incident angle.
